(19) United States
(12) Patent Application Publication
(10) Pub. No.: US 2017/0075107 A1
(43) Pub. Date: Mar. 16, 2017

(54) OPTICAL FIBER SCANNER, ILLUMINATION DEVICE, AND OBSERVATION APPARATUS

(71) Applicant: OLYMPUS CORPORATION, Tokyo (JP)

(72) Inventors: Kazutoshi KUMAGAl, Tokyo (JP); Yasuaki KASAI, Saitama (JP); Hiroshi TSURUTA, Kanagawa (JP); Yoshiro OKAZAKI, Tokyo (JP); Hirokazu YOKOTA, Tokyo (JP)

(73) Assignee: OLYMPUS CORPORATION, Tokyo (JP)

(21) Appl. No.: 15/360,388

(22) Filed: Nov. 23, 2016

Related U.S. Application Data
(63) Continuation of application No. PCT/JP2015/066662, filed on Jun. 10, 2015.

(30) Foreign Application Priority Data
Jun. 10, 2014 (JP) 2014-119397

(51) Int. Cl. G02B 26/10; G01M 11/00; G02B 23/24

(52) U.S. Cl. CPC G02B 26/103; G02B 23/2469; G01M 11/30; G02B 23/2476

(57) ABSTRACT

An optical fiber scanner including: an optical fiber that guides light produced by a light source; an actuator that is fixed at an intermediate position of the optical fiber in the long-axis direction and that displaces a distal end of the optical fiber through a bending vibration; and an electrically conductive detection wire member that extends in a state in which it is attached to the outer periphery of the optical fiber at least between the actuator and the distal end of the optical fiber, over a predetermined range in the long-axis direction.

### CROSS-REFERENCE TO RELATED APPLICATIONS

This is a continuation of International Application PCT/JP2015/066662, with an international filing date of Jun. 10, 2015, which is hereby incorporated by reference herein in its entirety. This application claims the benefit of Japanese Patent Application No. 2014-119397, filed on Jun. 10, 2014, the content of which is incorporated herein by reference.

### TECHNICAL FIELD

The present invention relates to an optical fiber scanner, an illumination device, and an observation apparatus.

### BACKGROUND ART

There is a known optical fiber scanner for scanning light two-dimensionally on an observation target by driving a piezoelectric element to spirally vibrate a distal end of an optical fiber (for example, see PTL 1).

In this optical fiber scanner, the distal end of the optical fiber, which passes through an inner hole of a cylindrical PZT (lead zirconate titanate) actuator provided with, on the outer surface, an electrode divided in quarters in the circumferential direction and which is supported in a cantilevered manner, is spirally moved through bending vibrations of the PZT actuator.

### CITATION LIST

### Patent Literature

### {PTL 1} Japanese Translation of PCT International Application, Publication No. 2008-504557

### SUMMARY OF INVENTION

### Technical Problem

Because the distal end of the optical fiber, which is supported in a cantilevered manner, is vibrated through vibration of the PZT actuator, which is located at the base, stress is concentrated on the base of the optical fiber due to the vibration of the distal end of the optical fiber, and thus the optical fiber may be broken or deformed. Then, if the movement of the optical fiber scanner is continued in a state in which the optical fiber is broken or deformed, the scan trajectory of light emitted from the optical fiber is disturbed.

The present invention is an optical fiber scanner, an illumination device, and an observation apparatus capable of preventing scanning in a disturbed scan trajectory from being continued when the optical fiber is broken or deformed.

### Solution to Problem

According to one aspect, the present invention provides an optical fiber scanner including: an optical fiber that guides light produced from a light source; an actuator that is fixed at an intermediate position of the optical fiber in a long-axis direction and that displaces a distal end of the optical fiber through a bending vibration; and an electrically conductive detection wire member that extends in a state in which it is attached to an outer periphery of the optical fiber at least between the actuator and the distal end of the optical fiber, over a predetermined range in the long-axis direction.

In the above-described aspect, the detection wire member may extend from the actuator to the vicinity of the distal end of the optical fiber.

In the above-described aspect, it is possible to further include an insulating member that has electrically insulating properties and that coats the detection wire member between the actuator and the distal end of the optical fiber.

In the above-described aspect, the detection wire member may be arranged so as to turn around at a location close to the distal end of the optical fiber and return on the outer periphery of the optical fiber in the long-axis direction.

In the above-described aspect, sections of the detection wire member that extend and return on the outer periphery of the optical fiber may be arranged at regular intervals in the circumferential direction of the optical fiber.

In the above-described aspect, the detection wire member may be formed of a thin film.

In the above-described aspect, the detection wire member may be formed of two layers of thin films that are formed in a laminated manner in the radial direction of the optical fiber, with an insulating thin film made of an electrically insulating material being sandwiched therebetween, and that are made to mutually conduct electricity by partially penetrating the insulating thin film at a location close to the distal end of the optical fiber.

In the above-described aspect, it is possible to further include a tubular vibration transferring member that has a through-hole through which the optical fiber passes and on an outer face of which the actuator is fixed, wherein the actuator may be formed of a piezoelectric element that performs a bending vibration when an oscillatory voltage is applied thereto; and the vibration transferring member may be formed of an electrically conductive material and may be electrically connected in series between the actuator and one end of the detection wire member.

According to another aspect, the present invention provides an illumination device including: a light source that produces light; the above-described optical fiber scanner; a focusing lens that focuses light scanned by the optical fiber scanner; and a blocking means that blocks light entering the optical fiber from the light source when the detection wire member is cut.

In the above-described aspect, it is possible to further include a light-source driving unit that drives the light source, wherein the light-source driving unit is grounded via the detection wire member.

According to still another aspect, the present invention provides an observation apparatus including: the above-described illumination device; and a light detecting unit that receives return light from an observation target when the illumination device radiates light onto the observation target.

### BRIEF DESCRIPTION OF DRAWINGS

FIG. 1 is a longitudinal sectional view showing an observation apparatus according to a first embodiment of the present invention.

FIG. 2 is a transverse sectional view of an optical fiber scanner of the observation apparatus shown in FIG. 1, cut along the line A-A.

FIG. 3 is a longitudinal sectional view showing a first modification of the optical fiber scanner of the observation apparatus shown in FIG. 1.

FIG. 4 is a transverse sectional view of an optical fiber scanner shown in FIG. 3, cut along the line B-B.

FIG. 5A is a longitudinal sectional view showing a state in which a detection wire member is attached to the outer periphery of an optical fiber, with an insulating thin film being sandwiched therebetween, according to a second modification of the optical fiber scanner of the observation apparatus shown in FIG. 1.

FIG. 5B is a longitudinal sectional view showing a state in which the detection wire member and the insulating thin film are chamfered in a direction intersecting the long axis, at a location close to the base end of the optical fiber and at a location close to the distal end thereof, according to the second modification of the optical fiber scanner of the observation apparatus shown in FIG. 1.

FIG. 5C is a longitudinal sectional view showing a state in which an adhesive is filled in a chamfered portion that is closer to the distal end of the optical fiber, according to the second modification of the optical fiber scanner of the observation apparatus shown in FIG. 1.

FIG. 5D is a longitudinal sectional view showing a state in which the detection wire member and actuators are electrically connected in series, according to the second modification of the optical fiber scanner of the observation apparatus shown in FIG. 1.

FIG. 6A is a longitudinal sectional view showing a state in which a detection wire member is attached to the outer periphery of an optical fiber, according to a third modification of the optical fiber scanner of the observation apparatus shown in FIG. 1.

FIG. 6B is a longitudinal sectional view showing a state in which the vicinities of both ends of the detection wire member are covered with masks at a location close to the base end of the optical fiber and at a location close to the distal end thereof, and a section between the masks is coated with an insulating thin film, according to the third modification of the optical fiber scanner of the observation apparatus shown in FIG. 1.

FIG. 6C is a longitudinal sectional view showing a state in which a section of the insulating thin film from a position in the long-axis direction of the optical fiber to the vicinity of the distal end of the optical fiber is coated with a detection wire member, and the two layers of the detection wire member mutually conduct electricity at a location close to the distal end, according to the third modification of the optical fiber scanner of the observation apparatus shown in FIG. 1.

FIG. 6D is a longitudinal sectional view showing a state in which the detection wire members and actuators are electrically connected in series, according to the third modification of the optical fiber scanner of the observation apparatus shown in FIG. 1.

FIG. 7 is a transverse sectional view showing a fourth modification of the optical fiber scanner of the observation apparatus shown in FIG. 1.

FIG. 8 is a longitudinal sectional view showing a fifth modification of the optical fiber scanner of the observation apparatus shown in FIG. 1.

FIG. 9 is a transverse sectional view of the optical fiber scanner shown in FIG. 8, cut along the line C-C.

FIG. 10 is a longitudinal sectional view showing a sixth modification of an apparatus body of the observation apparatus shown in FIG. 1.

FIG. 11 is a longitudinal sectional view showing a seventh modification of the apparatus body of the observation apparatus shown in FIG. 1.

FIG. 12 is a transverse sectional view of an optical fiber scanner shown in FIG. 11, cut along the line D-D.

FIG. 13 is a longitudinal sectional view showing an observation apparatus according to a second embodiment of the present invention.

FIG. 14 is a longitudinal sectional view showing an observation apparatus according to a third embodiment of the present invention.

### DESCRIPTION OF EMBODIMENTS

An optical fiber scanner 6, an illumination device 3, and an observation apparatus 1 according to a first embodiment of the present invention will be described below with reference to the drawings.

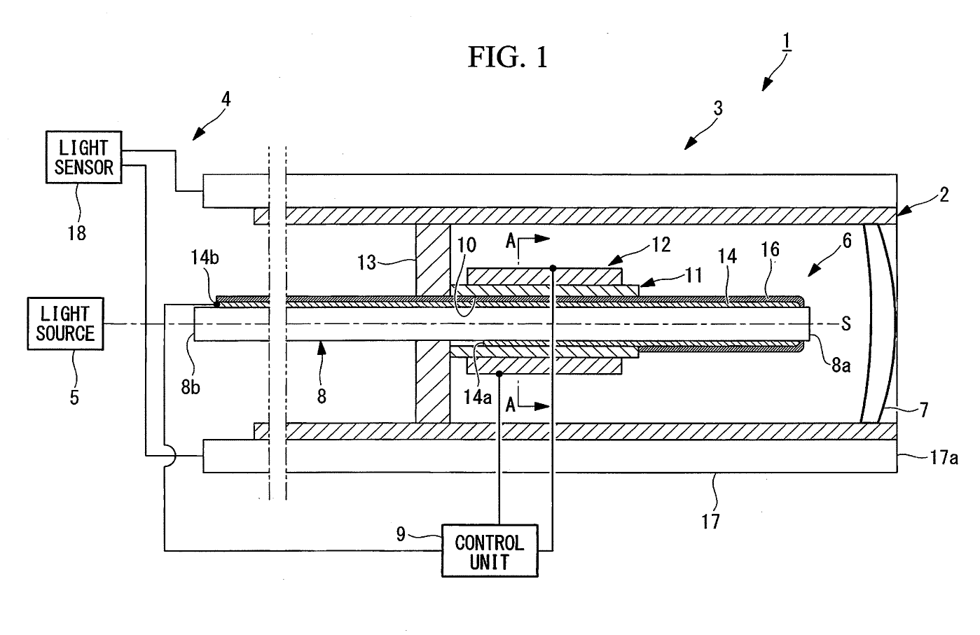

As shown in FIG. 1, the observation apparatus 1 of this embodiment is provided with a cylindrical apparatus body 2, an illumination device 3 that radiates illumination light, and a light detecting unit 4 that receives return light (for example, reflected light and fluorescence) from an observation target irradiated with the illumination light by the illumination device 3.

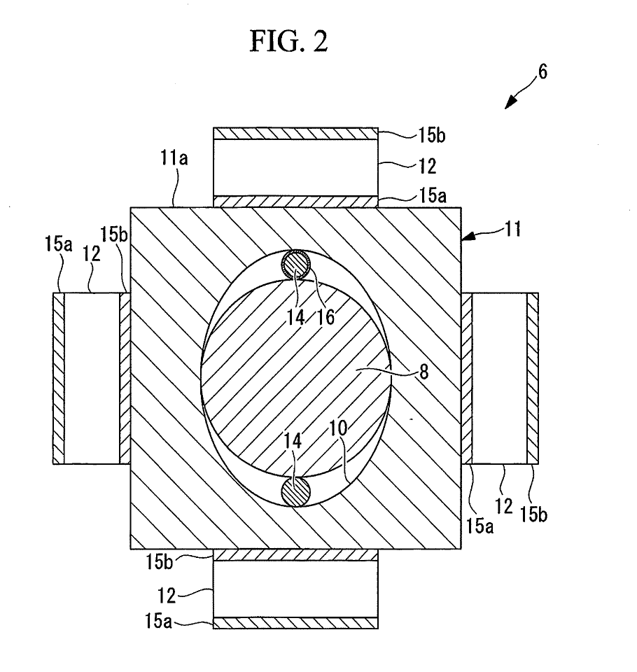

As shown in FIGS. 1 and 2, the illumination device 3 is provided with a light source (for example, laser diode) 5 that produces illumination light, the optical fiber scanner 6 of this embodiment that is accommodated in the apparatus body 2 and that two-dimensionally scans the illumination light, a focusing lens 7 that focuses the illumination light scanned by the optical fiber scanner 6, and a control unit 9 that controls the optical fiber scanner 6.

As shown in FIGS. 1 and 2, the optical fiber scanner 6 of this embodiment is provided with: an optical fiber 8 that guides illumination light from the light source 5; a vibration transferring member 11 that is formed of a square-tubular-shaped elastic member having a through-hole 10 through which the optical fiber 8 passes; four piezoelectric elements (actuators) 12 that are fixed to four outer faces 11a of the vibration transferring member 11; a supporting portion 13 that supports the optical fiber 8 with respect to the apparatus body 2 at a base end of the vibration transferring member 11; and a detection wire member 14 that is attached to the outer periphery of the optical fiber 8.

The piezoelectric elements 12 are each made to perform a bending vibration by an oscillatory voltage applied between electrodes 15a and 15b that are disposed on the both faces of the piezoelectric element 12 in the thickness direction. By making the piezoelectric elements 12 perform bending vibrations, the vibrations are transferred to the optical fiber 8 via the vibration transferring member 11, and a distal end 8a of the optical fiber 8, from which illumination light is emitted, is displaced in directions intersecting the long axis.

The piezoelectric elements 12 that are disposed on the opposing surfaces of the vibration transferring member 11 and that form a pair are disposed such that the front and rear surfaces thereof are opposite with respect to the vibration transferring member 11 and are fixed to the vibration transferring member 11 such that the directions of polarization are aligned in the same direction. Accordingly, for each pair of piezoelectric elements 12, the same voltages are applied to the electrodes 15 that are located at the outer sides, thereby making it possible to cause the pair of piezoelectric elements 12 to produce the same bending vibrations. Specifically, the two pairs of the four piezoelectric elements 12 can produce bending vibrations in two directions perpendicular to each other.

The vibration transferring member 11 is formed of an electrically conductive elastic member and is disposed at a position, in the long-axis direction of the optical fiber 8, that is distant from the distal end 8a by a predetermined gap toward a base end 8b of the optical fiber 8 along the long-axis direction.

The detection wire member 14 is an electrically conductive wire rod (for example, copper, aluminum, or the like). The detection wire member 14 extends, on the outer periphery of the optical fiber 8, from a location that is closer to the base end 8b than the supporting portion 13 is, to the vicinity of the distal end 8a, turns around in the vicinity of the distal end 8a, returns in the long-axis direction, and is electrically connected to the vibration transferring member 11 in the vicinity of one end 14a thereof.

The detection wire member 14, except for the vicinity of the end 14a, which is electrically connected to the vibration transferring member 11, is coated with an insulating thin film 16 that electrically insulates the detection wire member 14 from the surroundings.

Sections of the detection wire member 14 are attached to the optical fiber 8 at 180° intervals in the circumferential direction of the optical fiber 8.

The focusing lens 7 is fixed to a portion of the apparatus body 2 that is closer to the distal end than the optical fiber scanner 6 is and focuses illumination light scanned by the optical fiber scanner 6 on an observation target.

The control unit 9 applies, to the piezoelectric elements 12, voltages based on a predetermined scan trajectory that is input by an observer, such that illumination light emitted from the distal end 8a of the optical fiber 8 follows the predetermined scan trajectory. Furthermore, the control unit 9 is electrically connected to the piezoelectric elements 12 and the other end 14b of the detection wire member 14 and applies voltages to a position where displacement of the optical fiber 8 during vibration is small.

The light detecting unit 4 is provided with: detection optical fibers 17 that guide return light from the observation target toward the base end of the apparatus body 2; and a light sensor 18 that detects the intensity of the return light guided by the detection optical fibers 17.

The plurality of detection optical fibers 17 are fixed to the outer periphery of the apparatus body 2, with distal ends 17a facing frontward, and are arranged at regular intervals in the circumferential direction.

The light sensor 18 detects the total intensity of the return light received by the detection optical fibers 17.

The operation of the thus-configured optical fiber scanner 6, illumination device 3, and observation apparatus 1 of this embodiment will be described below.

In order to observe an observation target by using the observation apparatus 1 of this embodiment, first, the distal end 8a of the optical fiber 8 is made to face the observation target, and the control unit 9 applies a voltage between the two electrodes 15a and 15b of each of the piezoelectric elements 12. Accordingly, the piezoelectric elements 12 each perform a bending vibration in a way corresponding to the applied voltage, thereby displacing the distal end 8a of the optical fiber 8.

In this state, when illumination light from the light source 5 is made to enter the optical fiber 8, the illumination light guided through the optical fiber 8 is emitted from the distal end 8a of the optical fiber 8, and the illumination light focused by the focusing lens 7 and formed into a spot of light can be scanned on the observation target. Then, when the illumination light is radiated onto the observation target, return light (reflected light or fluorescence) returning from the observation target is received by the respective detection optical fibers 17 and is detected by the light sensor 18. Therefore, the scanning position and the intensity of the return light are stored in association with each other, thereby making it possible to acquire an image of the observation target.

In this case, if the vibrating optical fiber 8 is broken or deformed due to stress concentration or another cause, the detection wire member 14, which is disposed along the optical fiber 8, is cut. Because the detection wire member 14 forms an electrical series connection from the piezoelectric elements 12 to the control unit 9 via the vibration transferring member 11, if the detection wire member 14 is cut, voltages are not applied to the piezoelectric elements 12, and the movements of the piezoelectric elements 12 are terminated or suppressed, thus terminating scanning performed by the optical fiber scanner 6. Accordingly, it is possible to prevent the following situation in which displacement of the distal end 8a of the optical fiber 8 is continued while in an abnormal state in which the optical fiber 8 is broken or deformed, and then, heat is generated by friction between the vibration transferring member 11 or the supporting portion 13 and the optical fiber 8, thus increasing the temperature of the optical fiber scanner 6.

Specifically, if the detection wire member 14 is cut, scanning performed by the optical fiber scanner 6 is instantly terminated or suppressed; thus, there is an advantage that it is possible to prevent the scanning from being continued with a disturbed scan trajectory.

In this case, because the detection wire member 14 also serves as a grounding conductor for the control unit 9, there is an advantage that the electrical potential can be put in an unstable state if the detection wire member 14 is cut.

In this case, because the detection wire member 14 is coated with the insulating member 16, except for the vicinity of the end 14a of the detection wire member 14, there is an advantage that the influence on the detection wire member 14 from an outside electrical field is reduced, thus making it possible to accurately detect breakage and deformation of the optical fiber 8.

In this case, because the detection wire member 14 turns around in the vicinity of the distal end 8a and returns in the long-axis direction, a wire for electrically connecting to the control unit 9 is not required to be connected to the distal end 8a of the optical fiber 8, and thus it is possible to prevent a shift in the scan trajectory that would be caused by the wire and to accurately control the scan trajectory of the distal end 8a of the optical fiber 8.

In this case, because the sections of the detection wire member 14, which extend and return on the outer periphery of the optical fiber 8, are arranged at 180° intervals in the circumferential direction of the optical fiber 8, it is possible to prevent the weight balance of the optical fiber 8 in the circumferential direction from being unbalanced by the detection wire member 14 and to accurately control the scan trajectory of the distal end 8a of the optical fiber 8.

In this embodiment, an example detection wire member that extends, on the optical fiber 8, from a location that is closer to the base end 8b than the supporting portion 13 is and that turns around in the vicinity of the distal end 8a to return is shown as the detection wire member 14; however, the detection wire member is not limited thereto. For example, the detection wire member 14 may be attached, on the outer periphery of the optical fiber 8, to a range from the vibration transferring member 11 to the vicinity of the distal end 8a or may be attached, thereon, only to a range in the vicinity of a distal end of the vibration transferring member 11, where stress is relatively likely to be concentrated.

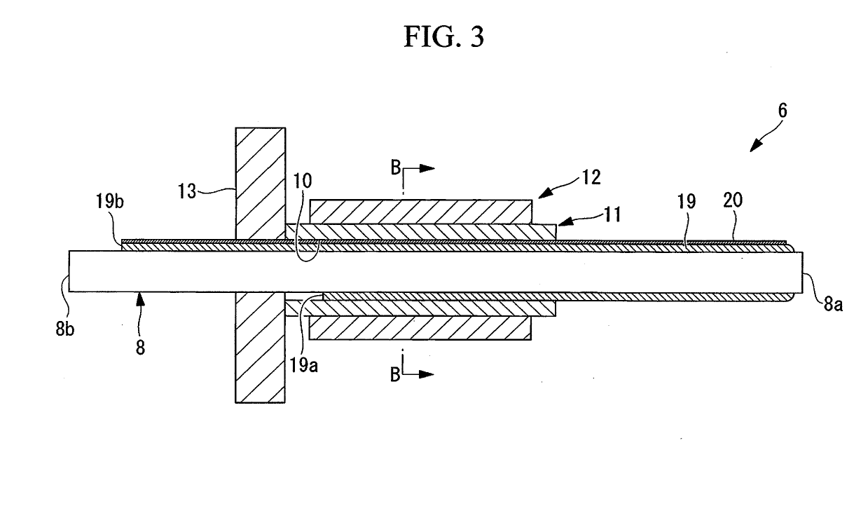

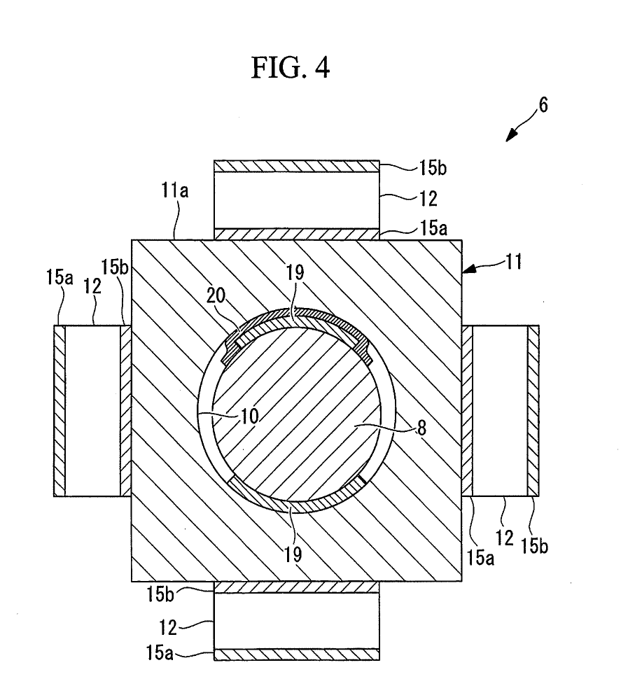

In this embodiment, although the detection wire member 14 formed of a wire rod is shown as an example detection wire member, the detection wire member is not limited thereto, and, as shown in FIGS. 3 and 4, a detection wire member 19 may be formed of a thin film made of an electrically conductive material.

Specifically, first, on the outer periphery of the optical fiber 8, the detection wire member 19, which extends, on a part of the optical fiber 8 in the circumferential direction, from a location close to the base end 8b to the vicinity of the distal end 8a, turns around in the vicinity of the distal end 8a, and further extends to an intermediate position, may be formed through coating, and then, the entire outer surface of a section of the detection wire member 19 that extends and returns on the outer periphery of the optical fiber 8 close to an end 19b side may be coated with an insulating member (hereinafter, simply referred to as insulating thin film) 20 that is a thin film having electrical insulation properties.

Accordingly, of the two sections extending and returning on the outer periphery of the optical fiber 8, the section close to the end 19a can be electrically conductive with the vibration transferring member 11, and the section close to the end 19b can be insulated from the vibration transferring member 11.

By doing so, the detection wire member 19 can be easily formed on the outer periphery of the optical fiber 8, and the detection wire member 19 is easily influenced by breakage and deformation of the optical fiber 8; thus, the sensitivity for detection of breakage and deformation of the optical fiber 8 can be further improved.

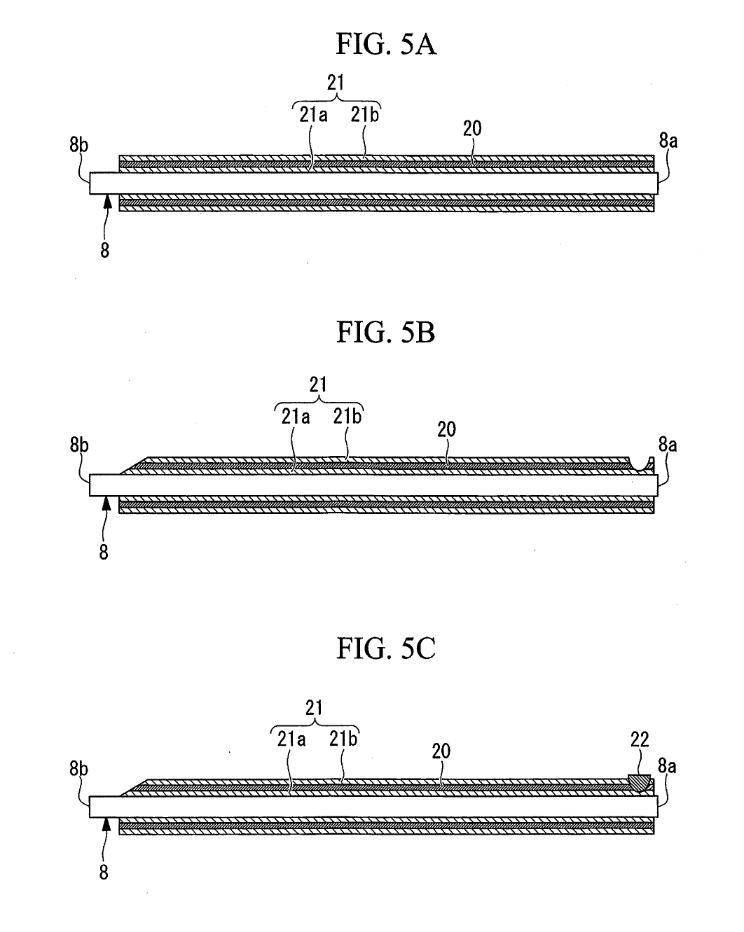

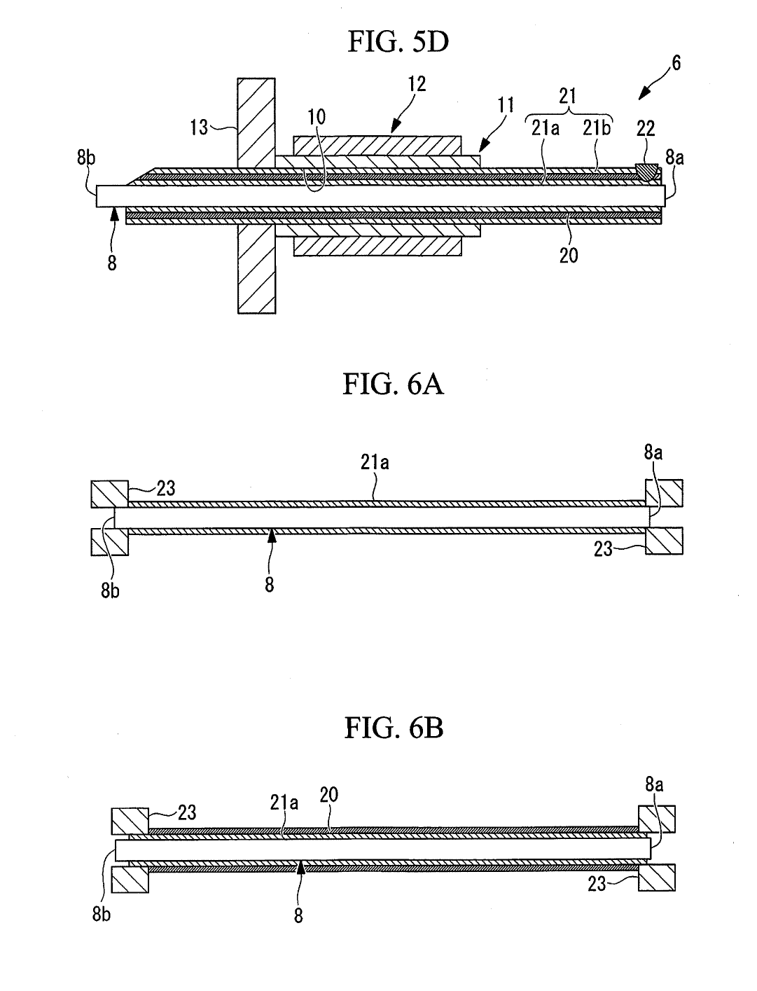

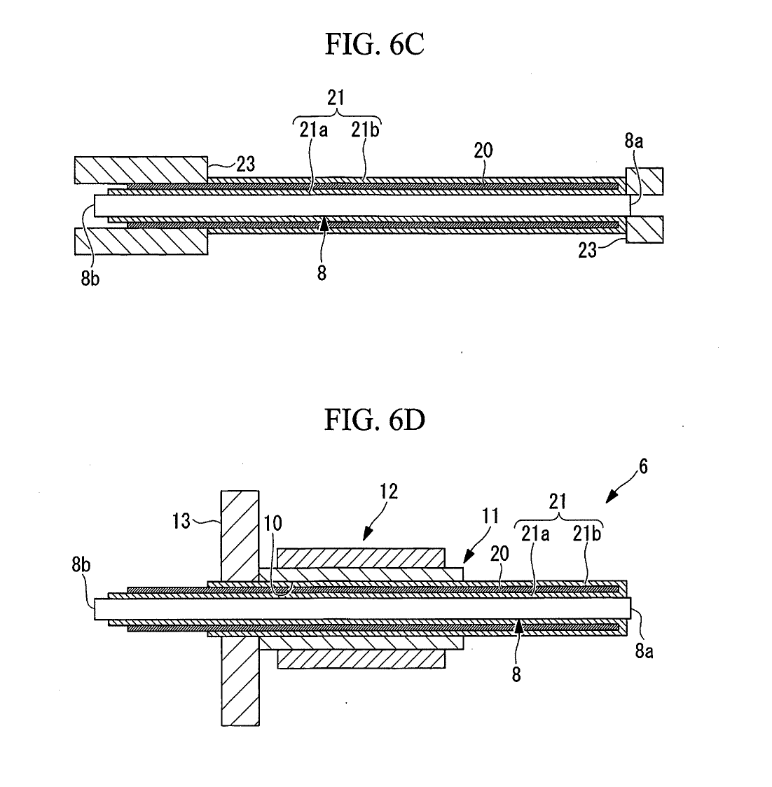

As shown in FIGS. 5A to 6D, it is also possible to adopt, as the detection wire member, a detection wire member 21 formed of two layers of thin films 21a and 21b that are formed in a laminated manner in the radial direction of the optical fiber 8, with the insulating thin film 20 being sandwiched therebetween, and that are made to conduct electricity therebetween by partially penetrating the insulating thin film 20 at a location close to the distal end 8a of the optical fiber 8.

To configure the detection wire member 21, as shown in FIGS. 5A to 5D, first, the entire outer periphery of the optical fiber 8 is coated with the thin film 21a, which is made of an electrically conductive material, the entire outer periphery of the thin film 21a is coated with the insulating thin film 20, and the entire outer periphery of the insulating thin film 20 is further coated with the thin film 21b. Next, both ends of each of the insulating thin film 20 and the thin film 21b are chamfered in a direction intersecting the long axis such that the thin film 21a is exposed in the radial direction. Then, an electrically conductive adhesive 22 is filled in a chamfered portion that is close to the distal end 8a, to make the two thin films 21a and 21b conduct electricity therebetween.

Instead of the above-described method, as shown in FIGS. 6A to 6D, first, the entire outer periphery of the optical fiber 8 is coated with the thin film 21a, which is made of an electrically conductive material, both ends of the coating thin film 21a are covered with masks 23, and an outer periphery of the thin film 21a that is exposed between the masks 23 is coated with the insulating thin film 20. Then, a section on the outer periphery of the insulating thin film 20 between a mask 23 that is located at one position in the longitudinal direction of the optical fiber 8 and a mask 23 that is located at a position slightly closer to the distal end than the distal end of the insulating thin film 20 is is coated with the thin film 21b, and the two thin films 21a and 21b may be connected at a position close to the distal end 8a.

With these methods, the thin films 21a and 21b, which are formed in a laminated manner with the insulating thin film 20 sandwiched therebetween, can be arranged such that they turn around at an electrically conductive section close to the distal end 8a of the optical fiber 8 in the radial direction and return in the long-axis direction.

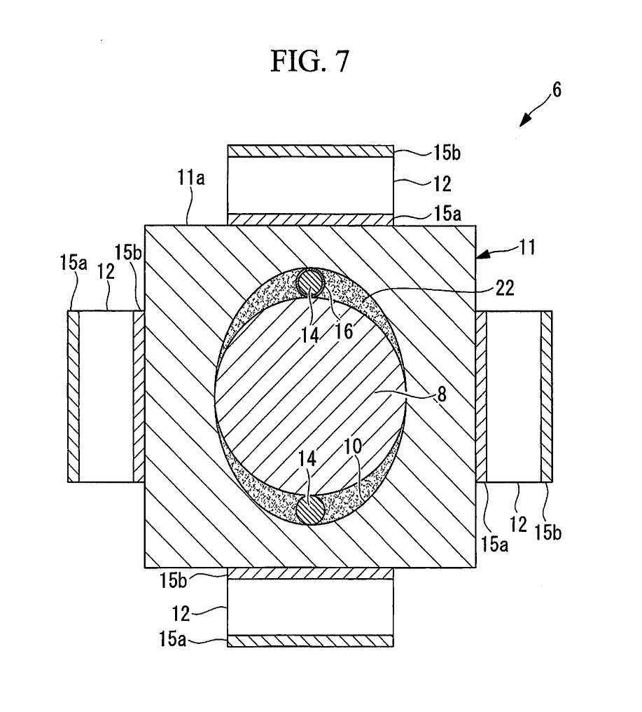

In this embodiment, as shown in FIG. 7, in the optical fiber scanner 6, an electrically conductive adhesive 22 may be filled in spaces existing between the inner periphery of the through-hole 10 and the outer periphery of the optical fiber 8, in the through-hole 10 of the vibration transferring member 11.

With this structure, the adhesion properties of the optical fiber 8, the detection wire member 14, the insulating member 16, and the vibration transferring member 11 are improved by filling the spaces, thus making it possible to further improve the efficiency of transmitting vibrations from the piezoelectric elements 12.

In this embodiment, as the piezoelectric elements 12, voltages are vibrationally applied to the four piezoelectric elements 12 to make them perform bending vibrations; however, the present invention is not limited thereto, and, for example, a single piezoelectric element 12 may perform a bending vibration. Furthermore, the scan trajectory is not limited to a two-dimensional trajectory and may be a one-dimensional trajectory, as long as it is in a direction intersecting an optical axis S.

In this embodiment, an example case in which the piezoelectric elements 12 are fixed to the vibration transferring member 11 and are indirectly fixed to the optical fiber 8 is shown; however, instead of this, it is also possible to directly fix the piezoelectric elements 12 to the outer periphery of the optical fiber 8, without using the vibration transferring member 11.

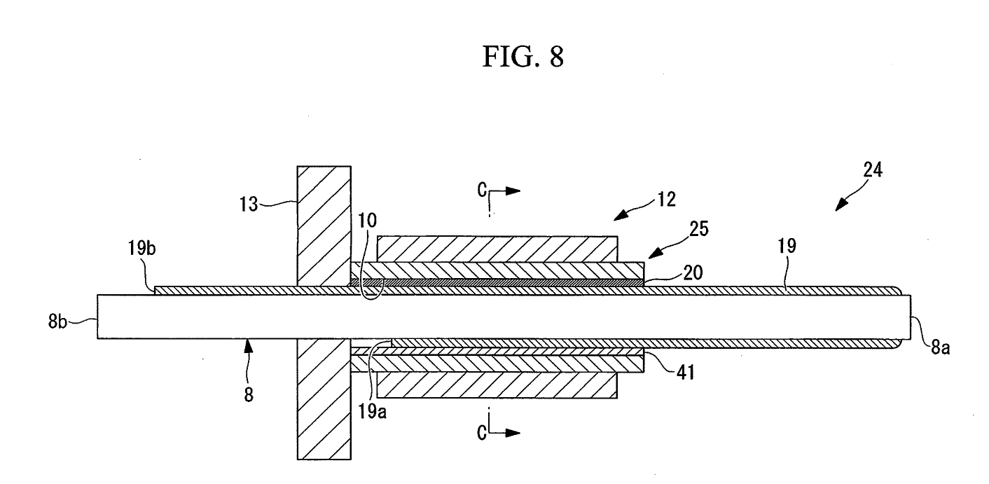

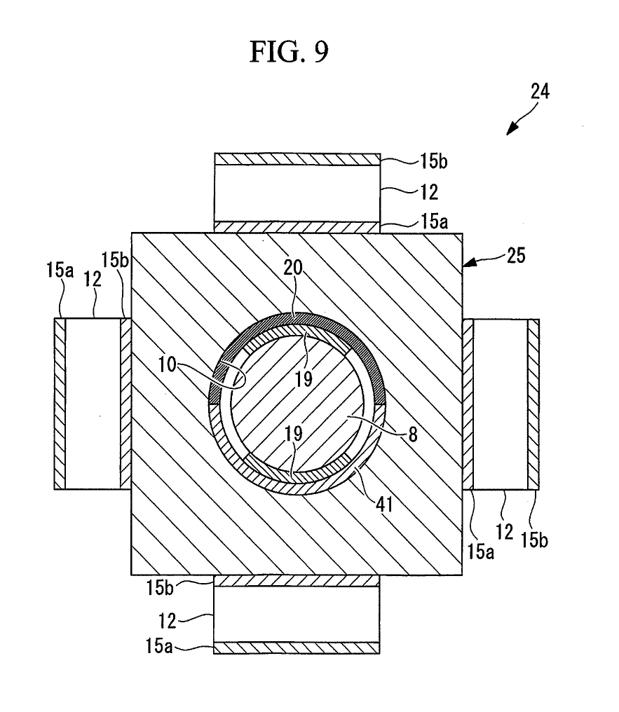

In this embodiment, an example optical fiber scanner in which the outer surface of the detection wire member 14, which is attached to the optical fiber 8, is covered with the insulating member 16 is shown as the optical fiber scanner 6; however, instead of this, as shown in FIGS. 8 and 9, it is also possible to adopt an optical fiber scanner 24 in which part of the inner periphery of the through-hole 10 of a vibration transferring member 25 in the circumferential direction is coated with the insulating thin film 20, and the remaining part thereof is coated with an electrically conductive thin film 41.

With this structure, because only the detection wire member 19, which is a thin film, is attached to the outer periphery of the optical fiber 8, it is possible to reduce the resistance to breakage and deformation of the optical fiber 8, thus further improving the detection accuracy of the detection wire member 19.

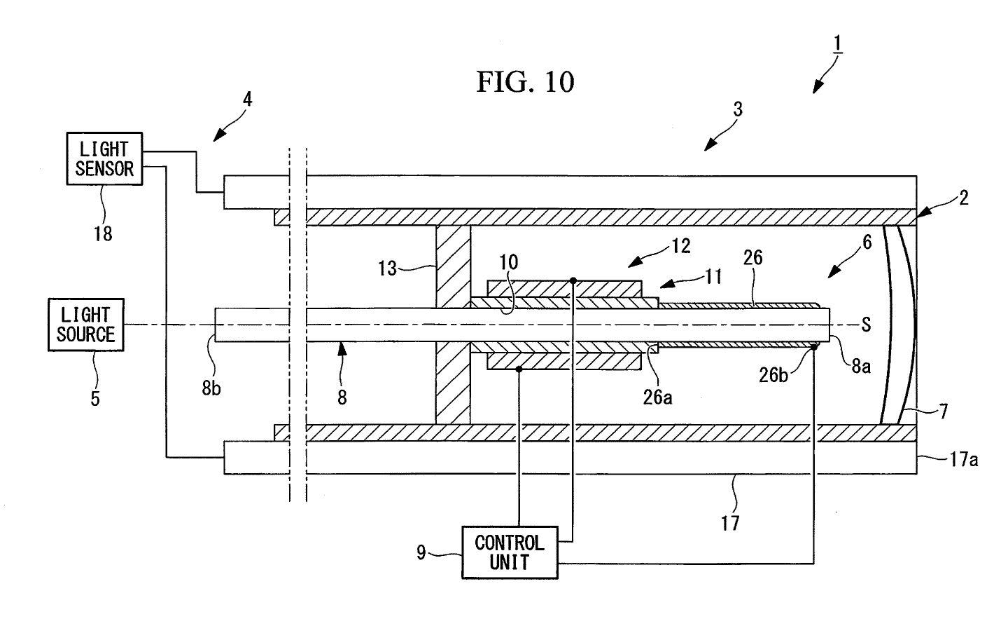

In this embodiment, the detection wire member 14, both ends 14a and 14b of which are disposed at locations that are closer to the base end 8b than the distal end of the vibration transferring member 11 is, is shown as an example; however, instead of this, as shown in FIG. 10, it is also possible to adopt a detection wire member 26 that is attached to the entire outer periphery of the optical fiber 8 from the vibration transferring member 11 to the vicinity of the distal end 8a and that is formed of a thin film made of an electrically conductive material.

Specifically, first, the detection wire member 26, which extends, on the entire outer periphery of the optical fiber 8, from the vibration transferring member 11 to the vicinity of the distal end 8a, is formed through coating, and one end 26a of the detection wire member 26 is electrically connected to the vibration transferring member 11. Then, wiring is performed in the vicinity of the distal end 8a of the optical fiber 8 so as to conduct electricity between the vicinity of the other end 26b of the detection wire member 26 and the control unit 9.

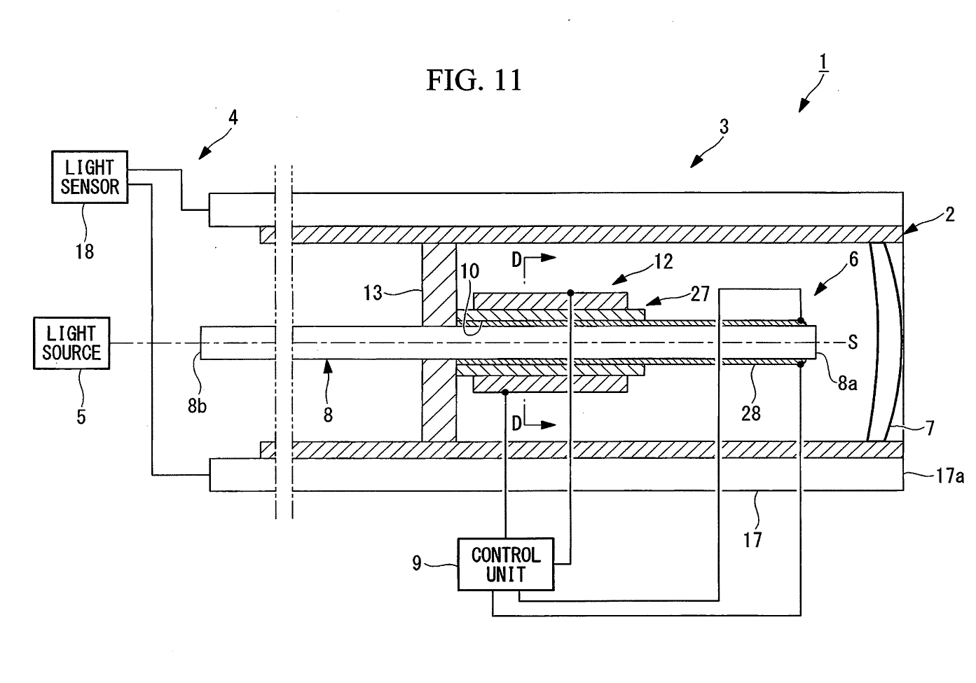

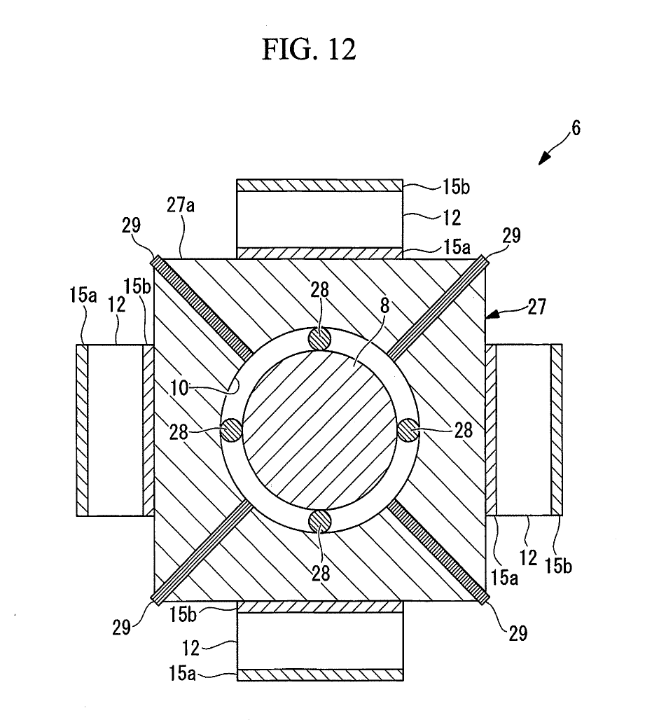

As shown in FIGS. 11 and 12, it is also possible to adopt detection wire members 28 that are formed of four electrically conductive wire rods extending, on the outer periphery of the optical fiber 8, from the vicinity of the distal end 8a of the optical fiber 8 toward the base end of a vibration transferring member 27.

In this case, electrically insulating layers 29 that define four sections in the vibration transferring member 27 are provided along diagonal lines in the cross-section of the vibration transferring member 27, so that the piezoelectric elements 12 fixed to outer faces 27a are not electrically connected to each other, and the electrically insulated sections of the vibration transferring member 27 are electrically connected to the corresponding detection wire members 28, individually.

With this structure, the piezoelectric elements 12 are set to the ground electrical potential, and the piezoelectric elements 12 can be individually driven.

Next, an illumination device 30 according to a second embodiment of the present invention will be described below with reference to the drawing.

In this embodiment, identical signs are assigned to portions having configurations common to those of the above-described illumination device 3 of the first embodiment, and a description thereof will be omitted.

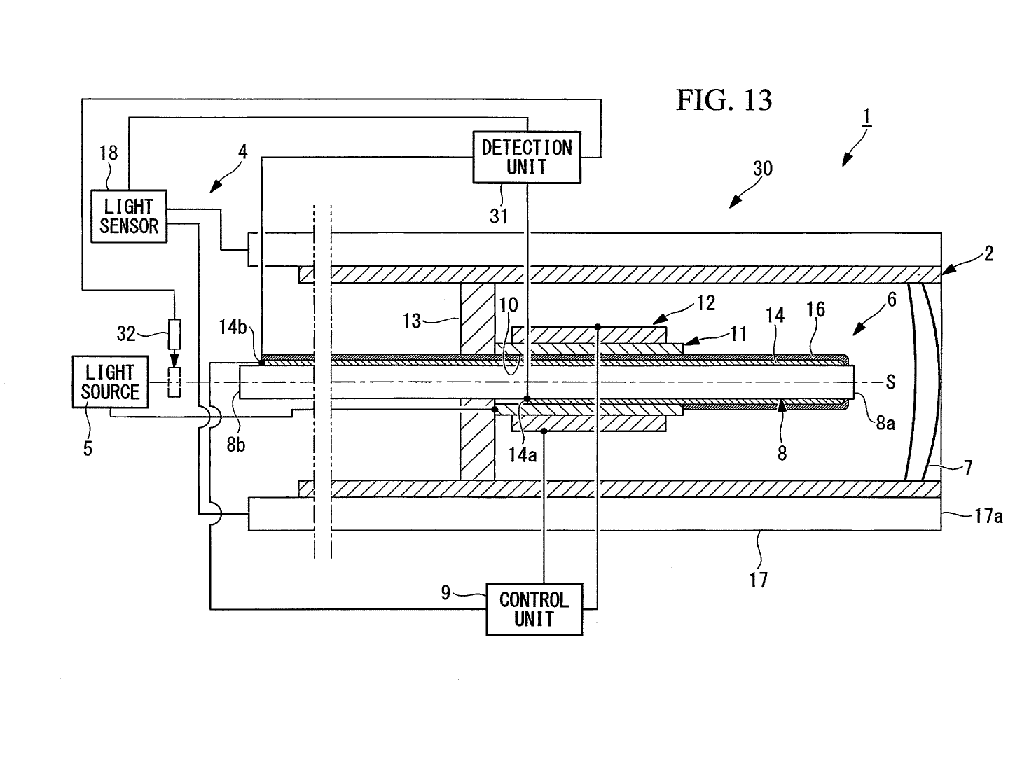

As shown in FIG. 13, the illumination device 30 of this embodiment differs from the illumination device 3 of the first embodiment in that the illumination device 30 is provided with a detection unit 31 that detects cutting of the detection wire member 14 and a blocking means 32 that does not allow illumination light from the light source 5 to enter the optical fiber 8 on the basis of a detection result from the detection unit 31.

The detection unit 31 is a circuit that applies a weak current between both ends 14a and 14b of the detection wire member 14 and that detects the voltage value thereof. If the detection wire member 14 is cut, the circuit is disconnected; thus, the voltage value detected by the detection unit 31 becomes zero, thus making it possible to determine that the optical fiber 8 has been broken or deformed.

The blocking means 32 is a shutter for blocking illumination light from the light source 5. The blocking means 32 blocks an optical path between the light source 5 and the optical fiber 8 when the detection unit 31 detects cutting of the detection wire member 14.

The operation of the thus-configured illumination device 30 of this embodiment will be described below.

In the illumination device 30 of this embodiment, the control unit 9 applies voltages to the piezoelectric elements 12 to displace the distal end 8a of the optical fiber 8. In this state, illumination light from the light source 5 is guided to the optical fiber 8, thereby making it possible to scan illumination light emitted from the distal end 8a of the optical fiber 8 on an observation target.

At this time, if the detection wire member 14 is cut, the circuit that forms a series electrical connection from the piezoelectric elements 12 to the control unit 9 is disconnected; thus, the bending vibrations of the piezoelectric elements 12 are terminated, and the detection unit 31 detects the cutting of the detection wire member 14 due to the disconnection of the circuit between both ends 14a and 14b of the detection wire member 14. When the detection unit 31 detects the cutting of the detection wire member 14, the detection unit 31 sends a drive signal to the shutter to activate the shutter, and the activated shutter blocks illumination light from the light source 5 before the light enters the base end 8b of the optical fiber 8.

Specifically, there is an advantage that, if the detection wire member 14 is cut due to breakage or deformation of the optical fiber 8, displacement of the distal end 8a of the optical fiber 8 and emission of illumination light from the distal end 8a can be instantly terminated.

In this case, because emission of illumination light from the distal end 8a of the optical fiber 8 does not continue while in an abnormal state in which the optical fiber 8 is broken, it is possible to prevent illumination light from being radiated onto one point for a long time.

In this embodiment, a blocking means using a shutter is shown as an example of the blocking means 32; however, the blocking means is not limited thereto, and, for example, it is also possible to adopt a configuration in which, when the detection unit 31 detects cutting of the detection wire member 14, a wire for supplying electric power from a power source (not shown) to the light source 5 is electrically blocked.

In this embodiment, the detection unit 31 detects a voltage value; however, instead of this, it is also possible to detect an electrical quantity for detecting cutting of the detection wire member 14, for example, a resistance value, a current value, a capacitance value, etc.

Next, an illumination device 33 according to a third embodiment of the present invention will be described below with reference to the drawing.

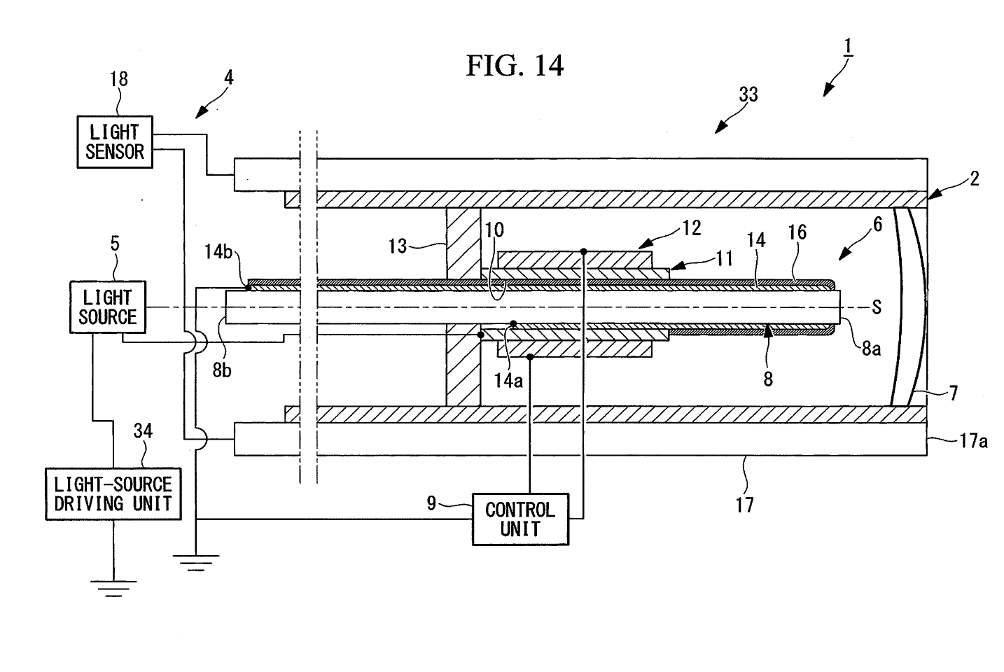

As shown in FIG. 14, the illumination device 33 of this embodiment differs from the illumination device 3 of the first embodiment in that a circuit that includes the light source 5 and a light-source driving unit 34 in series is provided in parallel with a circuit in which the control unit 9 applies voltages to the piezoelectric elements 12.

Specifically, the light-source driving unit 34 is connected to the vibration transferring member 11 via the light source 5, the circuit from the vibration transferring member 11 to the ground via the detection wire member 14 is common to the driving circuit, in which the control unit 9 drives the piezoelectric elements 12. The detection wire member 14 serves as a grounding conductor commonly for the control unit 9 and the light-source driving unit 34.

The operation of the thus-configured illumination device 33 of this embodiment will be described below.

In the illumination device 33 of this embodiment, the control unit 9 applies voltages to the piezoelectric elements 12 to displace the distal end 8a of the optical fiber 8, and the light-source driving unit 34 is driven to cause the light source 5 to produce light, thereby making it possible to scan the illumination light from the light source 5 on an observation target.

In this case, if the detection wire member 14 is cut, the circuit including the detection wire member 14 is disconnected, and the electrical potential at the control unit 9 and the light-source driving unit 34 becomes unstable; thus, the bending vibrations of the piezoelectric elements 12 and light emission of the light source 5 are instantly terminated or suppressed. Therefore, if the optical fiber 8 is broken or deformed, it is possible to terminate scanning performed by the optical fiber scanner 6 and to prevent an excessive heat generation at the light source 5 caused by producing of illumination light.

### REFERENCE SIGNS LIST

1 observation apparatus
3, 30, 33 illumination device
4 light detecting unit
5 light source
6, 24 optical fiber scanner
7 focusing lens
8 optical fiber
11, 25, 27 vibration transferring member
12 piezoelectric element (actuator)
14, 19, 21, 26, 28 detection wire member
16, 20 insulating member (insulating thin film)
32 blocking means
34 light-source driving unit

1. An optical fiber scanner comprising:
an optical fiber that guides light produced from a light source;
an actuator that is fixed at an intermediate position of the optical fiber in a long-axis direction and that displaces a distal end of the optical fiber through a bending vibration; and
an electrically conductive detection wire member that extends in a state in which it is attached to an outer periphery of the optical fiber at least between the actuator and the distal end of the optical fiber, over a predetermined range in the long-axis direction.

2. An optical fiber scanner according to claim 1, wherein the detection wire member extends from the actuator to the vicinity of the distal end of the optical fiber.

3. An optical fiber scanner according to claim 1, further comprising an insulating member that has electrically insulating properties and that coats the detection wire member between the actuator and the distal end of the optical fiber.

4. An optical fiber scanner according to claim 1, wherein the detection wire member is arranged so as to turn around at a location close to the distal end of the optical fiber and return on the outer periphery of the optical fiber in the long-axis direction.

5. An optical fiber scanner according to claim 4, wherein sections of the detection wire member, which extend and return on the outer periphery of the optical fiber, are arranged at regular intervals in the circumferential direction of the optical fiber.

6. An optical fiber scanner according to claim 1, wherein the detection wire member is formed of a thin film.

7. An optical fiber scanner according to claim 6, wherein the detection wire member is formed of two layers of thin films that are formed in a laminated manner in the radial direction of the optical fiber, with an insulating thin film made of an electrically insulating material being sandwiched therebetween, and that are made to mutually conduct electricity by partially penetrating the insulating thin film at a location close to the distal end of the optical fiber.

8. An optical fiber scanner according to claim 1, further comprising a tubular vibration transferring member that has a through-hole through which the optical fiber passes and on an outer face of which the actuator is fixed,
wherein the actuator is formed of a piezoelectric element that performs a bending vibration when an oscillatory voltage is applied thereto; and
the vibration transferring member is formed of an electrically conductive material and is electrically connected in series between the actuator and one end of the detection wire member.

9. An illumination device comprising:
a light source that produces light;
an optical fiber scanner according to claim 1;
a focusing lens that focuses light scanned by the optical fiber scanner; and
a blocking means that blocks light entering the optical fiber from the light source when the detection wire member is cut.

10. An illumination device according to claim 9, further comprising a light-source driving unit that drives the light source,
wherein the light-source driving unit is grounded via the detection wire member.

11. An observation apparatus comprising:
an illumination device according to claim 9; and
a light detecting unit that receives return light from an observation target when the illumination device radiates light onto the observation target.
